(19) United States
(12) Patent Application Publication
(10) Pub. No.: US 2012/0251885 A1
(43) Pub. Date: Oct. 4, 2012

(54) High power, wide-temperature range electrode materials, electrodes, related devices and methods of manufacture

(75) Inventors: DOUGLAS ELLSWORTH, North Vancouver (CA); KENT REDWINE, San Francisco, CA (US)

(73) Assignee: Blue Juice, Inc., San Rafael, CA (US)

(21) Appl. No.: 13/506,106

(22) Filed: Mar. 27, 2012

Related U.S. Application Data
(60) Provisional application No. 61/516,094, filed on Mar. 28, 2011.

(51) Int. Cl. H01M 4/485; H01B 1/08; B32B 3/26; C01G 23/04

(52) U.S. Cl. 429/231.1; 423/598; 252/520.21; 428/312.8

(57) ABSTRACT

The present invention is generally directed to the field of lithium-ion batteries. It is more specifically directed to electrode materials used in lithium ion batteries, electrodes including the materials, devices incorporating the electrodes and related methods of manufacture. In a composition aspect of the present invention, a composition comprising at least 50 mg of Li₄Ti₅O₁₂ or doped Li₄Ti₅O₁₂ is provided. The Li₄Ti₅O₁₂ or doped Li₄Ti₅O₁₂ is made using a thermal spray process, and is greater than 95% spinel crystal form. The BET surface area of the Li₄Ti₅O₁₂ or doped Li₄Ti₅O₁₂ is greater than 1 m²/g.

This application claims priority to U.S. Provisional Patent Appl. Ser. No. 61/516,094, filed Mar. 28, 2011, the entire disclosure of which is incorporated by reference into this document for all purposes.

### FIELD OF THE INVENTION

The present invention is generally directed to the field of lithium-ion batteries. It is more specifically directed to electrode materials used in lithium ion batteries, electrodes including the materials, devices incorporating the electrodes and related methods of manufacture.

### BACKGROUND OF THE INVENTION

U.S. Pat. No. 5,716,422 (the “'422 Patent”) is directed to an electrode component for an electrochemical cell. According to its abstract, the patent describes an electrode produced by thermal spraying an electrode active material onto a substrate to coat the substrate. It further reports that suitable thermal spraying processes include chemical combustion spraying and electrical heating spraying, using both wire and power processes.

Despite the work discussed in the '422 Patent, there is still a need in the art to develop other electrodes, processes for making the electrodes and devices including the electrodes.

### SUMMARY OF THE INVENTION

The present invention is generally directed to the field of lithium-ion batteries. It is more specifically directed to electrode materials used in lithium ion batteries, electrodes including the materials, devices incorporating the electrodes and related methods of manufacture.

In a composition aspect of the present invention, a composition comprising at least 50 mg of Li₄Ti₅O₁₂ or doped Li₄Ti₅O₁₂ is provided. The Li₄Ti₅O₁₂ or doped Li₄Ti₅O₁₂ is made using a thermal spray process, and is greater than 95% spinel crystal form. The BET surface area of the Li₄Ti₅O₁₂ or doped Li₄Ti₅O₁₂ is greater than 1 m²/g.

In another composition aspect of the present invention, a composition comprising at least 50 mg of Li₄Ti₅O₁₂ or doped Li₄Ti₅O₁₂ coated on a substrate is provided. The coating is made using a thermal spray process, and the Li₄Ti₅O₁₂ or doped Li₄Ti₅O₁₂ is greater than 95% spinel crystal form. The BET surface area of the Li₄Ti₅O₁₂ or doped Li₄Ti₅O₁₂ is greater than 1 m²/g, and the coating thickness ranges from 10 μm to 500 μm. The coating has a porosity greater than 5%.

In an article of manufacture aspect of the present invention, an electrode is provided. The electrode comprises Li₄Ti₅O₁₂ or doped Li₄Ti₅O₁₂ coated on a substrate. The coating is made using a thermal spray process, and the Li₄Ti₅O₁₂ or doped Li₄Ti₅O₁₂ is greater than 95% spinel crystal form. The BET surface area of the Li₄Ti₅O₁₂ or doped Li₄Ti₅O₁₂ is greater than 1 m²/g, and the coating thickness ranges from 10 μm to 500 μm. The coating has a porosity greater than 5%.

In another article of manufacture aspect of the present invention, an electrochemical cell is provided. The electrochemical cell comprises an electrode. The electrode comprises Li₄Ti₅O₁₂ or doped Li₄Ti₅O₁₂ coated on a substrate. The coating is made using a thermal spray process, and the Li₄Ti₅O₁₂ or doped Li₄Ti₅O₁₂ is greater than 95% spinel crystal form. The BET surface area of the Li₄Ti₅O₁₂ or doped Li₄Ti₅O₁₂ is greater than 1 m²/g, and the coating thickness ranges from 10 μm to 500 μm. The coating has a porosity greater than 5%.

### DETAILED DESCRIPTION OF THE INVENTION

The electrode materials of the present invention are Li₄Ti₅O₁₂ spinel, or doped Li₄Ti₅O₁₂ spinel, produced using one or more thermal spray processes. Any suitable thermal spray process may be used, but it is typically one of the following: plasma spraying; detonation spraying; wire arc spraying; flame spraying; high-velocity oxy-fuel coating spraying (HVOF); warm spraying; and cold spraying.

A thermal spray system typically includes: a spray torch (or gun), which is an element that melts and accelerates particles for deposition; a feeder for supplying powder, wire or liquid to the spray torch; media supply, which are gases or liquids used in generating the flame or plasma jet or gases for carrying powder; a robot for manipulating the spray torch or substrates that are coated by the process; a power supply; and a control console for the other elements.

Plasma spraying involves the introduction of a material into a plasma jet, which is generated by a plasma torch. The material is typically a powder, liquid, suspension or wire. The plasma jet provides a high temperature environment (˜10,000 K), which melts the material as it is propelled toward a surface. Molten droplets of the material hit the substrate, flatten and rapidly solidify. Variation of process parameters—e.g., plasma gas composition, flow rate, energy input, torch offset distance, and substrate cooling—can provide material depositions with different characteristics.

Nonlimiting examples of plasma spraying process variation involve the following parameters: plasma jet generation; plasma-forming medium; and spraying environment. The plasma jet can be generated by direct current (DC plasma) or induction (RF plasma). Plasma forming media can be gas-stabilized plasma (GSP), water-stabilized plasma (WSP) or hybrid plasma. The spraying environment can involve air plasma spraying (APS), controlled atmosphere plasma spraying (CAPS), high-pressure plasma spraying (HPPS), low-pressure plasma spraying (LPPS), vacuum plasma spraying (VPS) or underwater plasma spraying.

Wire arc thermal spraying involves the independent feeding of two consumable metal wires into a spray gun. The wires are charged, an arc is generated between them, and the heat generated from the arc melts new wire as it is fed into the system. Molten metal from the wire is entrained in air jet from the spray gun and is deposited on a surface. One type of wire arc spraying is plasma transferred wire arc. For this type of process, the molten metal coating is deposited on the internal surface of a cylinder or the external surface of a part having any geometry.

High velocity oxygen fuel spraying (HVOF) involves the mixture of gaseous or liquid fuel with oxygen in a combustion chamber, where the mixture is continuously ignited and combusted. Hot gas at a pressure close to 1 MPa flows through a converging-diverging nozzle, traveling through a straight section. The gas exit velocity is typically >1000 m/s, which exceeds the speed of sound. Material in the form of a powder is injected into the gas stream, and the powder particles are accelerated to speeds up to around 800 m/s. The material partially melts in the stream and is subsequently deposited on a substrate.

Cold spraying involves the acceleration of material to high speeds by means of a carrier gas forced through a converging-diverging de Laval type nozzle. Solid particles deform plastically on impact with sufficient kinetic energy to metallurgically bind the particles to a substrate.

Warm spraying is an HVOF modification, where the combustion gas temperature is lowered by mixing nitrogen with it. This modification typically increases coating efficiency.

The electrode materials of the present invention are either non-substrate bound or substrate bound (e.g., adhered or chemically bonded to the substrate). Where the materials are non-substrate bound, the Li₄Ti₅O₁₂ , or doped Li₄Ti₅O₁₂, particles typically have the following characteristics:

average primary particle size ranging from 0.5 μm to 100 μm, with average sizes oftentimes ranging from 5.0 μm to 100 μm;

BET surface area ranging from 1.0 m²/g to 50 m²/g, with surface areas oftentimes ranging from 3.0 m²/g to 40 m²/g, 5.0 m²/g to 35 m₂/g and 7.5 m²/g to 30 m²/g;

partial, hollow spheres morphology with a typical “shell” thickness ranging from 1.0 nm to 100 nm, oftentimes 5.0 nm to 50 nm;

spinel phase purity >95%, typically >97%.

Doped Li₄Ti₅O₁₂ typically includes one or more metals (e.g., Nb, Ta, V, Zr, Mo, Mn, Fe, Cu, Co) in a small amount, such as 0.01 to 5.0 weight percent. One example of a doped material is Li₄Ti_{4.95}Nb_{0.05}O₁₂.

Where the electrode materials are substrate bound, the thickness of material coated onto the substrate oftentimes ranges from 10 μm to 500 μm, with some thicknesses ranging from 20 μm to 100 μm. Surface area of the substrate bound Li₄Ti₅O₁₂, or doped Li₄Ti₅O₁₂, typically ranges from 0.5 m²/g to 50 m²/g. In certain cases, the surface area ranges from 1.0 m²/g to 45 m²/g, 3.0 m²/g to 40 m²/g, 5.0 m²/g to 35 m²/g or 7.5 m²/g to 30 m²/g. The substrate bound material is oftentimes porous, with average pore sizes typically ranging from 0.1 μm to 150 μm or 1.0 μm to 100 μm. Porosity of the bound material oftentimes ranges from 1.0% to 60%, 2.5% to 55%, 5.0% to 50%, 10% to 45% or 15% to 40%. Phase purity of the bound material is usually >95% spinel, with purity oftentimes >97% or >98%.

The substrate is typically a metal, metal alloy, metalloid, mixed metal, metal oxide, mixed metal oxide, or carbon-based polymer. Nonlimiting examples of substrate compositions include: alumina, silicon, gallium arsenide, copper or aluminum.

For manufacture of the electrode material, substrate bound or not, the feed material is typically introduced into the thermal sprayer as a slurry/suspension, liquid/solution or powder. Nonlimiting examples of a slurry include:

Li₄Ti₅O₁₂ or doped Li₄Ti₅O₁₂ at a concentration of 5.0 to 50 weight % in ethanol, water or a mixture of ethanol and water;

5.0 to 50 weight % TiO₂, with a stoichiometric amount of LiOH, LiNO₃ or LiOAc in ethanol and/or water;

5.0 to 50 weight % TiO₂ with a stoichiometric amount of LiOH, LiNO₃ or LiOAc and between 0.1 weight % and 5.0 weight percent of a dopant source in ethanol and/or water.

A non-limiting example of a solution is Ti(Oi-Pr)₄ with a stoichiometric amount of LiOAc in ethanol. A non-limiting example of a powder is Li₄Ti₅O₁₂, or doped Li₄Ti₅O₁₂, that is >95% spinel, with a surface area ranging from 0.5 m2/g to 50 m2/g, and an average particle size of 0.5 μm to 10.0 μm.

The materials of the present invention, or substrate-bound materials, are typically included in an anode (with other suitable additives if necessary), which is further included in an electrochemical cell.

1. A composition comprising at least 50 mg of Li₄Ti₅O₁₂ or doped Li₄Ti₅O₁₂, wherein the Li₄Ti₅O₁₂ or doped Li₄Ti₅O₁₂ is made using a thermal spray process, and wherein the Li₄Ti₅O₁₂ or doped Li₄Ti₅O₁₂ is greater than 95% spinel crystal form, and wherein the BET surface area of the Li₄Ti₅O₁₂ or doped Li₄Ti₅O₁₂ is greater than 1 m²/g.

2. A composition comprising at least 50 mg of Li₄Ti₅O₁₂ or doped Li₄Ti₅O₁₂ coated on a substrate, and wherein the coating is made using a thermal spray process, and wherein the Li₄Ti₅O₁₂ or doped Li₄Ti₅O₁₂ is greater than 95% spinel crystal form, and wherein the BET surface area of the Li₄Ti₅O₁₂ or doped Li₄Ti₅O₁₂ is greater than 1 m²/g, and wherein the coating thickness ranges from 10 μm to 500 μm, and wherein the coating has a porosity greater than 5%.

3. An electrode, wherein the electrode comprises Li₄Ti₅O₁₂ or doped Li₄Ti₅O₁₂ coated on a substrate, and wherein the coating is made using a thermal spray process, and wherein the Li₄Ti₅O₁₂ or doped Li₄Ti₅O₁₂ is greater than 95% spinel crystal form, and wherein the BET surface area of the Li₄Ti₅O₁₂ or doped Li₄Ti₅O₁₂ is greater than 1 m²/g, and wherein the coating thickness ranges from 10 μm to 500 μm, and wherein the coating has a porosity greater than 5%.

4. An electrochemical cell, wherein the electrochemical cell comprises an electrode, and wherein the electrode comprises Li₄Ti₅O₁₂ or doped Li₄Ti₅O₁₂ coated on a substrate, and wherein the coating is made using a thermal spray process, and wherein the Li₄Ti₅O₁₂ or doped Li₄Ti₅O₁₂ is greater than 95% spinel crystal form, and wherein the BET surface area of the Li₄Ti₅O₁₂ or doped Li₄Ti₅O₁₂ is greater than 1 m²/g, and wherein the coating thickness ranges from 10 μm to 500 μm, and wherein the coating has a porosity greater than 5%.
